(19) United States
(12) Patent Application Publication
(10) Pub. No.: US 2011/0000978 A1
(43) Pub. Date: Jan. 6, 2011

(54) AUTONOMOUS SPRAYING DEVICE HAVING A ROTATING DISC

(76) Inventors: Jean-Marc Chichep-Ortiche, Paris (FR); Najib Zainoun, Noisy-le-Grand (FR); Jean-Pierre Renaudeaux, Chevreuse (FR)

Correspondence Address: TREGO, HINES & LADENHEIM, PLLC, 9300 HARRIS CORNERS PARKWAY, SUITE 210, CHARLOTTE, NC, 28269-3797, US

(21) Appl. No.: 12/065,185

(22) PCT Filed: Jun. 6, 2006
(86) PCT No.: PCT/FR2006/001263

§ 371 Date: Sep. 16, 2010

(30) Foreign Application Priority Data
Jun. 6, 2005 (FR) 05/05752

(51) Int. Cl. B05B 3/02

(52) U.S. Cl. 239/222.11

(57) ABSTRACT

The invention relates to an atomizer, which has a rotating disc, is miniaturized and which is easily portable. Numerous uses exists according to the power source used. When the source of energy is a battery, this system, which is autonomous and portable, is particularly suited for domestic uses. When the power source is the mains supply or pneumatic, this system, which is portable, is particularly suited for industrial uses, and when the power used is renewable, this system, which is autonomous, is especially for uses in an isolated medium, for example, for desalinating sea water or oxygenating lagoon systems. The atomizer is principally composed of: a rapidly rotating disc; a system for supplying liquid to the disk; a fan enabling the aerosol to be directed in the desired direction; a motor; the power source thereof, and; control and checking devices. The invention is characterized by the fact that the functions of spraying, pumping and fanning are effected by the same rotor.

The present invention concerns a portable system designed to spray autonomously or not a liquid contained in a reservoir. This system consists of a disk, bolus or other object with axial rotational symmetry that atomizes the liquid, of a device for liquid feed of the disk from a fixed or removable and interchangeable reservoir and, if necessary, of a fan designed to orient in the desired direction the paths of the drops coming from the rotating disk. Depending on the applications, this system is activated by an electric motor fed by the power supply main, cell, battery or any other energy source, such as solar energy, a pneumatic motor or a wind power engine driving the rotor directly or by means of a speed increasing or decreasing system.

When the system is activated by an electric motor fed by a cell or battery, the present invention is particularly intended to generate autonomously aerosols for domestic use: cosmetics, household products, pharmaceuticals, food products, paints and varnishes. When the system is activated by an electric motor fed by the power supply main or a pneumatic motor thus making a lower operating cost possible, this invention is particularly intended to generate technical aerosols for more intensive use. When the system is directly activated by a wind power engine or when the energy source is derived from renewable energy, such as solar energy, the invention is especially intended for permanent or semi-permanent use, as in the oxygenation of water in lagoon systems or the spraying of sea water for desalinization. The applications and examples given here are solely by way of illustration and are not restrictive or exclusive.

It is known that when it is desired to spray liquids in droplets and with a considerable rate of flow, that can be done in two different ways. The first method, called nozzle spraying, consists of expelling a liquid contained in a reservoir under pressure through a nozzle. On passage from that nozzle, there is a liquid spray and formation of droplets, the rate of flow and size of which depend on the upstream pressure, shape of the nozzle and method of pressurization. The second method, called rotating disk spraying, results from the natural or controlled fragmentation into drops of a liquid coming from a fast rotating disk. The rate of flow and size of the drops depend mainly on the speed of rotation and dimensions of the object in rotation. In stationary industrial spraying installations, both methods are used concurrently, according to the products to be sprayed. In case rotating disks are used, the diameters of the disks usually exceed 5 cm and they are driven by motors whose power is mainly linked to the nature of the products to be sprayed. In case nozzles are used, the liquid is pressurized in the majority of cases by an air compressor dedicated to the compressed air apparatus or system of the plant.

In the case of autonomous and portable domestic applications or industrial installations, the apparatuses most commonly used are aerosol generators, often called aerosol pumps, consisting of a reservoir containing the active liquid pressurized by a gas and sprayed through a nozzle. The gases used are either gases compressed under pressures of several bars (for example, CO₂), or dissolved gases, or in some cases liquefied gases. Those gases, called propellants, are accused or participating in the greenhouse effect (CO₂) and/or of posing a certain hazard, like the highly inflammable dissolved gases used in butane. Furthermore, aerosol pumps are subject to the legislation on pressure apparatuses. Some portable aerosol generators use disks or turbines to atomize the liquids. Examination of French Patents 2,371,969 and FR 49,092 and U.S. Pat. Nos. 6,138,925 and 5,727,541 shows that in all cases, the liquid feed tube ends in one or more orifices of small sections designed to pressurize the liquid and, finally, the disk or turbine is fed by one or more jets, not enabling the liquid to be spread directly or homogeneously on the disk or turbine.

The object of the invention is to propose a portable and/or autonomous atomizer for domestic or industrial use, not requiring any propellant, ensuring all the functions for producing an aerosol from a reservoir placed at atmospheric pressure or at a pressure close to atmospheric pressure, low enough not to be placed in the regulatory area of pressure pumps. That system is compatible with the controlled aerosol spray heads described in French Patent 04 03679. It does not require the presence of orifices upstream from the disk. The absence of propellant, miniaturization, combination of several ordinarily separate functions in a same assembly and the absence of orifices or nozzles, always subject to clogging and sources of disruption of flow, as well as the possibility of effectively controlling size grading, constitute definite advantages over the methods currently used.

For a proper understanding of the description of the different embodiments, it is pointed out in advance: (1) that the functions to be fulfilled in order to accomplish such objective are to activate in rapid rotation a disk, bolus or any other object with axial rotational symmetry, to supply at least one face of that disk, bolus or object with axial rotational symmetry with a sufficient flow of liquid and, if necessary, to alter the path of the drops naturally in the plane of the disk, so that they easily reach the target sought; (2) that the energy to be supplied in order to disperse the liquid in drops at the edge of a rotating disk is in steady state in the order of several watts for rates of flow of several cc/sec, flows ordinarily used in those applications; (3) that the energy to be provided in order to supply the disk with liquid depends on the load difference between the reservoir and the disk, the delivery and the losses in the level of flows and that the power to be supplied in order to raise the water several cc with a delivery in the order of several cc/sec is several milliwatts; (4) that the vortex created on rotating a liquid volume in a container with free surface changes the free surface, giving it the shape of a paraboloid of revolution whose height near the walls is greater than the height at rest; (5) that the static pressure and dynamic pressure existing on both sides of the plane of the fan propeller are different from atmospheric pressure and have a value which can be approached by Bernoulli's law.

The invention accomplishes its objective thanks to improvements introduced in devices of disk sprayer type, containing a flat disk, small dish or object with axial rotational symmetry driven by a motor. These improvements are characterized by the use of disks of small diameters in the order of a centimeter, by the inclusion on the motor-disk shaft of the liquid feed device and fan serving to direct the aerosols produced, by the connection of that assembly to the reservoir, by the absence of nozzles or orifices upstream from the flat disk, small dish or object with rotational symmetry, by the use of overpressure created near the fan and by the possibility of controlling the size of the aerosols produced.

The different embodiments described below by way of illustration for accomplishing the object sought have in common the fact that they contain, on one side, a rotor that turns the disk, participating in its liquid supply and bearing the fan propeller, if necessary, and, on the other, a frame containing the stationary parts of the fans, liquid feed device, reservoir or reservoir fastening device and different conduits, as well as the operating and control parts. They differ mainly in the nature of the liquid feed device of the disk, in the relative position of the various components, in the method of drive and in the energy source.

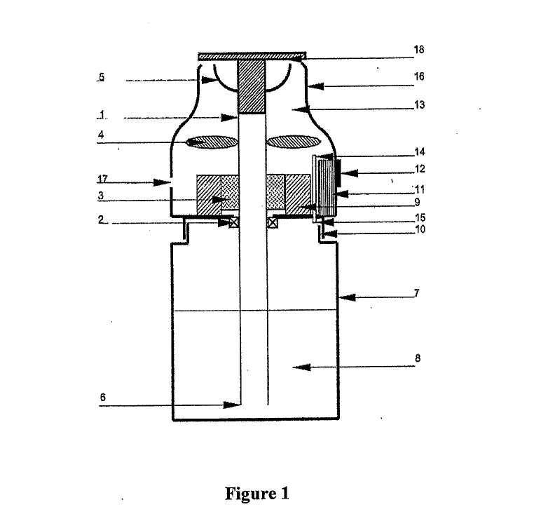

In one embodiment of the system according to the invention, as can be seen in FIG. 1, the rotor consists of a rod (1) driven by the rotor (3) of the motor, supporting a revolving joint (2) and possibly the rotor (4) of the fan. That rod (1) is hollow and contains at one of its ends a flat disk, small dish or object with axial rotational symmetry (5). On its other end (6), it dips into the reservoir (7) containing the liquid to be sprayed (8). The frame supports the stator of the motor (9), the system of attachment of the reservoir (10) by screwing, for example, the location of the energy source (11), the electric connectors and the switch (12). That frame is crossed, on one side, by an air supply circuit (13) of the fan propeller (4) and, on the other, when the system is equipped with a fan, by a conduit whose end near the plane of the propeller of the fan (14) constitutes a static or dynamic pressure tap and whose other end opens into the reservoir (7) above or below the free surface of the liquid. When the end is above the free surface of the liquid, the reservoir is at constant pressure, and when the end is below the free surface, the reservoir functions like a Mariotte's bottle. That conduit can be equipped at the end (7) with a nonreturn valve (15). The frame is placed in a casing (16) in which air inlets (17) are bored, ensuring the design of the system. The frame can be equipped with a hood (18) protecting the disk against shocks and dirt and ensuring the tightness of the system. On rotation of the disk by closing the switch, a forced vortex is created inside the shaft. The free surface rises along the walls until reaching the surface of the disk (according to the speed of rotation) and thus enabling the flow on the disk. The pumping efficiency can be improved by piercing the interior surface of the shaft like an Archimedean screw, as well as by pressurizing the reservoir in case of the presence of the fan thanks to the conduit (14) connecting the near plane of the fan to the reservoir. In this case, the nonreturn valve prevents the filling of that conduit by the spray liquid (8) in case of operating error or overhead reservoir use.

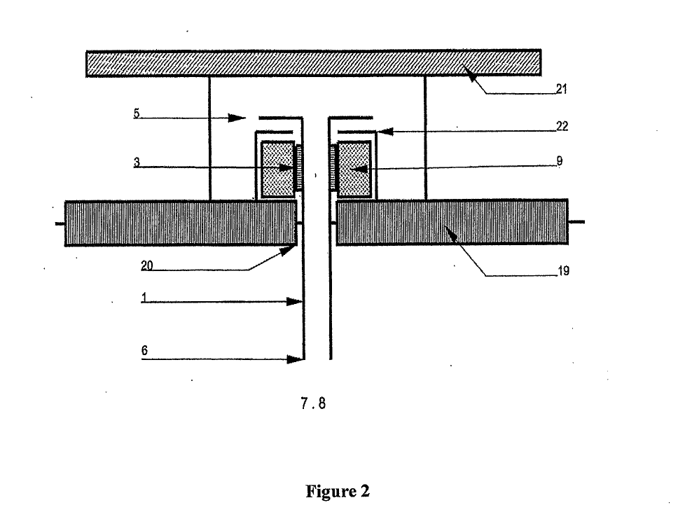

In another embodiment of the system according to the invention, as can be seen in FIG. 2, an embodiment particularly intended for lagoon system, water treatment and/or desalinization applications, in which the reservoir (8) is a large expanse of water with free surface, compared to the dimensions of the system: the rotor consists of a rod (1) driven by the rotor (3) of the motor. That rod is hollow and contains at one of its ends a flat disk, small dish or object with axial rotational symmetry (5). Its other end (6) dips into the reservoir (7) containing the liquid to be sprayed (8). The frame is a float (19) in which an orifice (20) is bored, letting the rod (1) pass and on which the motor (9) is fastened, as well as its energy source (21), such as photovoltaic cells. The motor (3, 9) is placed in a casing (22) protecting it. The frame can be anchored, for example, to the bottom of the reservoir or freely diverge. On rotation of the disk, a forced vortex is created inside the shaft. The free surface rises along the walls until reaching the surface of the disk (according to the speed of rotation) and thus enables flow on the disk. The efficiency of pumping can be improved by piercing the inner surface of the shaft like an Archimedean screw. That precaution proves particularly necessary when it is desired to pump water at a certain depth.

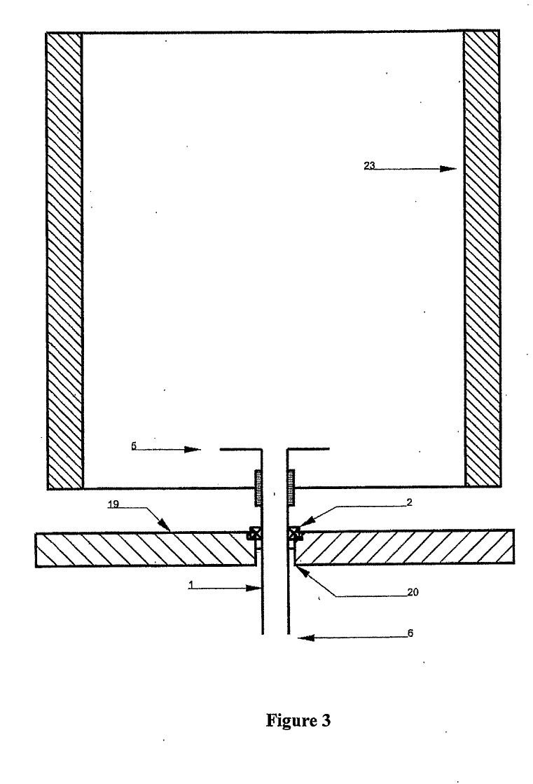

In another embodiment of the system according to the invention, as can be seen in FIG. 3, an embodiment particularly intended for lagoon system, water treatment and/or desalinization applications, in which the reservoir (8) is a large expanse of water with free surface, compared to the dimensions of the system: the rotor consists of a rod (1) supporting a revolving joint (2), driven by the rotor of a wind power engine (23) with vertical shaft directly or by means of a speed increasing-decreasing system such as a gear system. That rod (1) is hollow and contains at one of its ends a flat disk, small dish or object with axial rotational symmetry (5). Its other end (6) dips into the reservoir (7) containing the liquid to be sprayed (8). The frame is a float (19) in which an orifice (20) is bored, receiving the revolving joint and possibly supporting the frame of the wind power engine (23). The frame can be anchored, for example, to the bottom of the reservoir or freely diverge. On rotation of the disk, a forced vortex is created inside the shaft. The free surface rises along the walls until reaching the surface of the disk (according to the speed of rotation) and thus enables flow on the disk. The efficiency of pumping can be improved by piercing the inner surface of the shaft like an Archimedean screw.

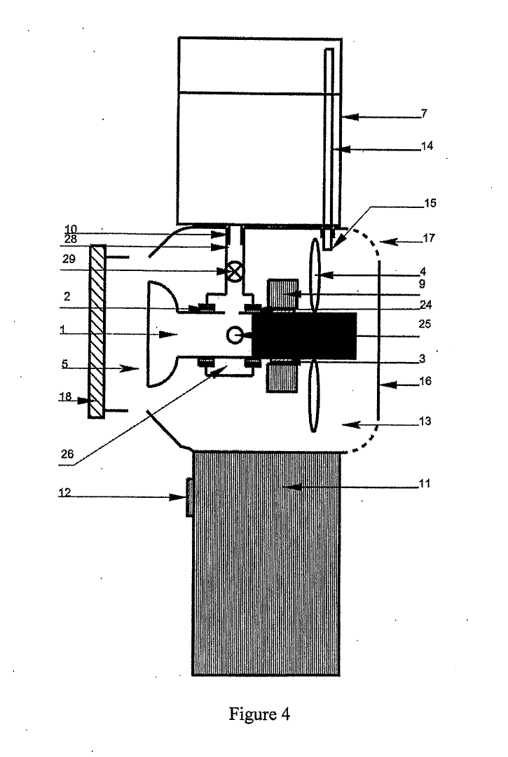

In another embodiment of the system according to the invention, as can be seen in FIG. 4, the rotor consists of a rod (1) driven by the rotor (3) of the motor, supporting two revolving joints (2) and (24) and possibly the fan rotor (4). That rod (1) contains at one of its ends (5) a flat disk, small dish or object with axial rotational symmetry and is hollow in the part between the revolving joint (24) closest to the motor and the end supporting the flat disk, small dish or object with axial rotational symmetry (5). The rod is solid in the part crossing the motor. It has a number of orifices (25) bored in one or more sections situated between the two rotating joints (2) and (24). Those orifices are solely intended to enable the liquid to pass from the chamber (26) to the tube (1). The interior surface of the hollow rod and/or the interior surface of the flat disk, small dish or object with axial rotational symmetry can be provided with grooves facilitating the flow to the end of the disk or object with rotational symmetry. The frame supports the stator of the motor (9), the system of fastening the reservoir (10), the location of the energy source (11), the electric connectors and the switch (12). That frame also supports the stator of the liquid feed device, which is a chamber (26) concentric to the rotor (1) and connected to the latter by the revolving joints (2) and (24). That chamber is open on the surface facing the rod and provided with one or more orifices on its opposite face, enabling a connection to the reservoir by one or more tubes (28). A valve (29) makes possible the opening and closing of the liquid feed circuit. The frame is crossed on one side by the air supply circuit (13) of the fan propeller (4) and, on the other, when the system is equipped with a fan, by a conduit (14) whose end near the plane of the fan propeller constitutes a static or dynamic pressure tap and whose end opens into the reservoir above or below the free surface of the liquid. When the end is above the free surface of the liquid, the reservoir is at constant pressure, and when the end is below the free surface, the reservoir functions like a Mariotte's bottle. That conduit (14) can be equipped at one end with a nonreturn valve (15). The frame is placed in a casing (16) in which air inlets (17) are bored, ensuring the design and protection of the system. The frame can be equipped with a hood (18) protecting the disk against shocks and dirt. The system operates as follows: on closing of the switch (12) starting the rotor, the valve (29) connecting the reservoir and the supply chamber opens and the liquid initially in the reservoir fills the chamber (26), either under the effect of gravity, if the reservoir is placed above the chamber, or under the effect of pressurization of the reservoir by operation of the fan if the reservoir is placed in another position. The liquid from the chamber passes through the orifices (25) inside the hollow tube and reaches the disk under the combined effect of the vortex and of the pressure generated. It then spreads over the disk and is fragmented into droplets on its periphery or near its periphery. As can be easily understood, that system operates whatever the relative position of the reservoir in relation to the disk.

In another embodiment of the system according to the invention, as can be seen in FIG. 5, the rotor consists of a rod (1) driven by the rotor (3) of the motor, supporting a revolving joint (24) and possibly the fan rotor (4). That rod (1), which is solid, contains at one of its ends a flat disk, small dish or object with axial rotational symmetry (5). The outer surface of the rod and/or the surface of the flat disk, small dish or object with axial rotational symmetry can be provided with grooves facilitating the flow from the disk to the end of the flat disk, small dish or object with axial rotational symmetry. The frame supports the stator of the motor (9), the system of fastening the reservoir (10) by screwing, for example, the location of the energy source (11), the electric connectors and the switch (12). That frame also supports the stator of the liquid feed device (26), which is a chamber concentric to the rotor and connected to the latter by the revolving joint (24) situated between the chamber and the motor. In the part situated between the disk and the revolving joint the chamber is extended by a concentric tube (30) to the rod and of interior diameter slightly greater than the diameter of the rod, thus letting the liquid flow out of the chamber along the rotating shaft. The chamber is provided with one or more orifices on its outer surface, making possible a connection by one or more tubes (28) to the reservoir. The frame is crossed on one side by the air supply circuit (13) of the fan propeller (4) and, on the other, when the system is equipped with a fan, by a conduit (14) whose end near the plane of the propeller constitutes a static or dynamic pressure tap and whose other end opens into the reservoir above or below the free surface of the liquid. When the end is above the free surface of the liquid, the reservoir is at constant pressure, and when the end is below the free surface, the reservoir functions like a Mariotte's bottle. That conduit (14) can be equipped at the end with a nonreturn valve (15). The frame is placed in a casing (16) in which air inlets (17) are bored, ensuring the design and protection of the system. The frame can be equipped with a hood (18) protecting the disk against shocks and dirt. The system operates as follows: on closing of the switch (12) starting the rotor, the valve (29) connecting the reservoir and the supply chamber opens and the liquid initially in the reservoir fills the chamber under the effect of gravity if the reservoir is placed above the chamber, or under the effect of pressurization of the reservoir by operation of the fan if the reservoir is placed in another position and/or under the pumping effect created by rotation of the liquid between the stator and the rotor. The liquid from the chamber flows through the annular orifice formed between the rod (1) and the tube (30) and spreads over the rear face of the disk by centrifugal effect. It is fragmented into droplets on its periphery or near its periphery.

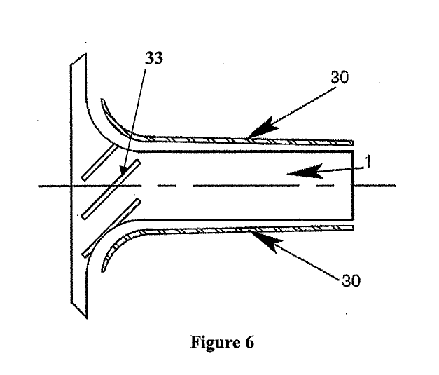

According to a variant of that embodiment shown in FIG. 6, the tube (30) can be usefully extended along the divergent part connecting the disk and the tube and be provided with grooves (33). The flow in that zone is then comparable to that existing in an axial-flow pump.

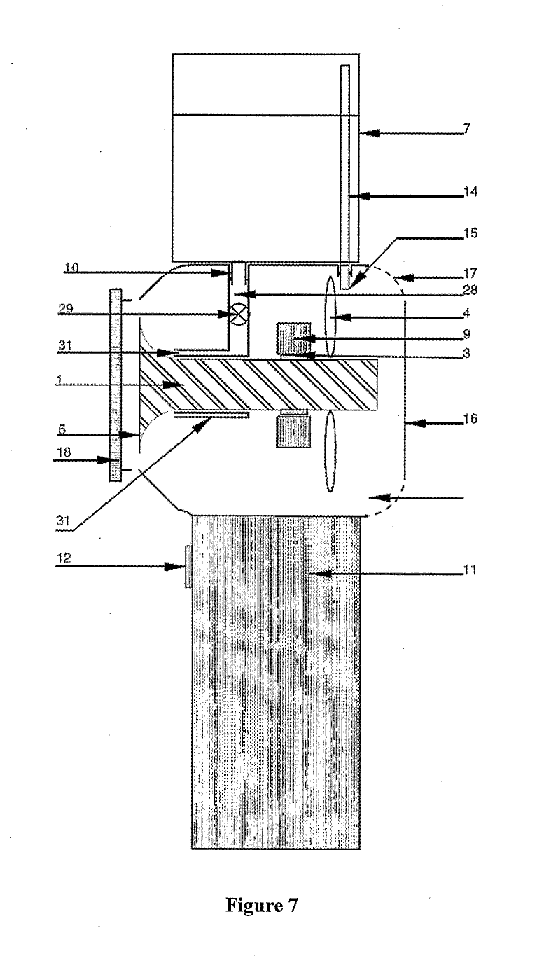

In another embodiment of the system according to the invention, as can be seen in FIG. 7, the rotor consists of a rod (1) driven by the rotor (3) of the motor and possibly of the fan rotor (4). That rod (1), which is solid, contains at one of its ends a flat disk, small dish or object with axial rotational symmetry (5). The frame supports the stator of the motor (9), the system of fastening the reservoir (10) by screwing, for example, the location of the energy source (11), the electric connectors and the switch (12). That frame also supports the liquid feed device (31), which is an annular tube coaxial and concentric to the rotor, of inner diameter slightly greater than the rotor and connected to the reservoir by an elbow followed by a tube. The frame is crossed on one side by the air supply circuit (13) of the fan propeller (4) and on the other, when the system is equipped with a fan, by a conduit (14) connecting an air inlet machined in the plane close to the propeller and the reservoir (7). That conduit (14) can be equipped at one end with a nonreturn valve (15). The frame is placed in a casing (16) bored with air inlets (17), ensuring the design and protection of the system. The frame can be equipped with a hood (18) protecting the disk against shocks and dirt. The system operates as follows: on closing of the switch (12) starting the rotor, the valve (29) connecting the reservoir and the supply chamber opens and the liquid initially in the reservoir fills the tube (31) under the effect of gravity, if the reservoir is placed above the chamber, or under the effect of pressurization of the reservoir by operation of the fan if the reservoir is placed in another position. At the outlet of the tube (31), the liquid flows along the disk and spreads over its rear face by centrifugal effect. It is fragmented into droplets on its periphery or near its periphery.

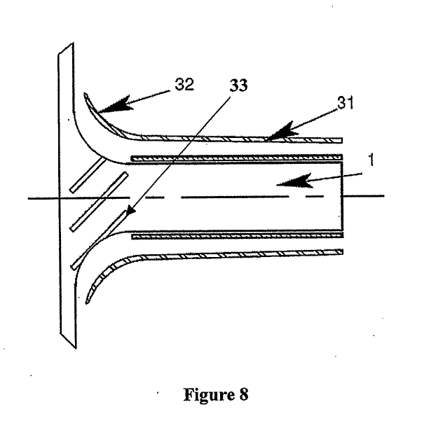

According to a variant of that embodiment shown in FIG. 8, that straight coaxial tube (31) can be extended by a conical surface of revolution (32) situated in the extension of the outer wall of the tube. That conical surface envelops the zone of connection between the axis of rotation and the disk and can be provided with grooves (33). The flow in that zone is then comparable to that existing in an axial-flow pump.

1. Aerosol system of atomizer type with rotating disk containing an object with axial rotational symmetry, such as a flat disk, driven in rotation at high speed by a motor, a stationary or removable reservoir and a liquid feed device, characterized in that an axis of a rotor of the liquid feed device of the object with axial rotational symmetry is merged with the axis of rotation of said object and set up to generate, on the rotation of said object with axial rotational symmetry, the rise of the liquid along its walls up to the object with axial rotational symmetry in the form of free surface and the flow of said liquid over at least one face of said object up to the periphery of the latter.

2. Aerosol system according to claim 1, characterized in that a rod of the rotor of the liquid feed device is hollow and opens on the disk, the free surface of the liquid rising inside the hollow shaft along its walls and flowing over the disk.

3. System according to claim 1, characterized in that a rod of the rotor of the liquid feed device is hollow and contains helical grooves therein.

4. Aerosol system according to claim 1, characterized in that a rod of the rotor of the liquid feed device is solid and extends across a concentric tube from a chamber concentric to the rod in connection with the liquid reservoir, the free surface of the liquid flowing through an annular orifice formed by the solid rod and the tube and spreading over a rear face of the disk by centrifugal effect.

5. Aerosol system according to claim 1, characterized in that a rod of the rotor contains helical grooves on its outside.

6. Aerosol system according to claim 1, characterized in that the object with axial rotational symmetry contains helical grooves on the face receiving the liquid.

7. Aerosol system according to claim 4, characterized in that the concentric tube contains helical grooves therein.

8. Aerosol system according to claim 4, characterized in that the concentric tube is extended by a divergent tube guiding the liquid along the rear face of the object with axial rotational symmetry, the free surface of the liquid spreading over the rear face of the disk by centrifugal effect.

9. Aerosol system according to claim 1, characterized in that a rod of the rotor of the liquid feed device is solid and extends across a concentric coaxial tube in connection with the liquid reservoir, the free surface of the liquid spreading over the rear face of the disk by centrifugal effect.

10. Aerosol system according to claim 9, characterized in that the concentric coaxial tube is extended by a divergent tube guiding the liquid along the rear face of the object with axial rotational symmetry, the free surface of the liquid spreading over the rear face of the disk by centrifugal effect.

11. Aerosol system according to claim 10, characterized in that the divergent tube contains helical grooves therein.

12. Aerosol system according to one of claim 1, characterized in that it contains a fan making it possible to direct the aerosols at the outlet of the disk, an axis of a rotor of the fan rotor being merged with the axis of the disk and of the liquid feed device.

13. System according to claim 1, characterized in that the motor enabling the rotation of the flat disk or object with axial rotational symmetry is a wind power engine with a vertical shaft directly engaged on a shaft of the disk and feed device or coupled to that shaft by a speed increasing or decreasing device.

14. System according to claim 13, characterized in that the speed increasing or decreasing device is composed of gears.

15. System according to claim 13, characterized in that the speed increasing or decreasing device is a belt device.

16. System according to claim 1, characterized in that a rod of the rotor of the liquid feed device is a hollow shaft of the disk, driven by a motor with hollow shaft and dipping into the liquid reservoir.

17. System according to claim 1, characterized in that the feed device consists of a chamber concentric to the axis of rotation, fed under a slight pressure by the reservoir and feeding liquid through orifices to a hollow rod between that chamber and the disk.

18. System according to claim 12, characterized in that the liquid reservoir is put under a slight pressure by means of a tube connecting it to an upstream surface of the fan.

19. System according to claim 1, characterized in that a stator of the feed device consists of a chamber concentric to the axis of rotation, fed under a slight pressure by the reservoir and containing at its end a conduit concentric to a rod and of diameter slightly greater than the rod, enabling the liquid to reach the disk through an annular orifice.

20. System according to claim 1, characterized in that the reservoir and/or the disk and its shaft are removable and interchangeable.
